(19) United States
(12) Patent Application Publication
(10) Pub. No.: US 2007/0001406 A1
(43) Pub. Date: Jan. 4, 2007

(54) Press in place seal for a water softener control valve

(76) Inventor: Anil N. Mehta, Glendale, WI (US)

Correspondence Address: QUARLES & BRADY LLP, 411 E. WISCONSIN AVENUE, SUITE 2040, MILWAUKEE, WI, 53202-4497, US

(21) Appl. No.: 11/170,215

(22) Filed: Jun. 29, 2005

(51) Int. Cl. F16J 15/02

(52) U.S. Cl. 277/644

(57) ABSTRACT

A water treatment apparatus has a two components with surfaces that face each other wherein one surface has an annular groove therein. A sealing ring is provided for placement in the annular groove to form a water tight seal between the two components. The sealing ring has an annular body with an inner perimeter and an outer perimeter. One or more fins project away from either the inner perimeter or the outer perimeter for engaging a wall of the annular groove and spacing the respective inner perimeter or outer perimeter away from the wall. During assembly of the water treatment apparatus, the fins and not the entire inner perimeter or an outer perimeter engage the groove wall thereby enabling the sealing ring to be easily pressed into the groove which facilitates the assembly.

### BACKGROUND OF THE INVENTION

The present invention relates to apparatus for softening water; and more particularly to seals for the control valve assembly of the water softening apparatus.

It is quite common for water drawn from a well to be considered “hard” in that it contains di-positive and sometimes tri-positive ions which have leached from mineral deposits in the earth. Such ions form insoluble salts with common detergents and soaps producing precipitates that increase the quantity of detergent or soap required for cleaning purposes. When hard water is used in boilers, evaporation results in the precipitation of insoluble residues that tend to accumulate as scale.

It is standard practice to install a water softener in the plumbing system of a building that is supplied with hard water. The most common kind of water softener is an ion exchange apparatus that has a tank which holds a bed of resin through which the hard water flows to remove undesirable minerals and other impurities. Binding sites in the resin bed initially contain positive ions, commonly unipositive sodium or potassium ions. As hard water enters the resin, competition for the binding sites occurs. The di-positive and tri-positive ions in the hard water are favored due to their higher charge densities and displace the unipositive ions. Two or three unipositive ions are displaced for each di-positive or tri-positive ion, respectively.

The capacity of the rein bed to absorb minerals and impurities is finite and eventually ceases to soften the water when a large percentage of the sites become occupied by the di-positive and tri-positive ions. When this occurs, it becomes necessary to recharge or regenerate the resin bed by flushing it with a regenerant, typically a solution of sodium chloride or potassium chloride. The concentration of unipositive ions in the regenerant is sufficiently high to offset the unfavorable electrostatic competition and the binding sites are recovered by unipositive ions. The interval of time between regeneration periods during which water softening takes place is referred to as a service mode of operation.

When regeneration of a water softener is to occur is determined by a controller which may be s simple timer that triggers regeneration at regular intervals or the controller may sense water usage of conductivity of the resin bed to determine when regeneration is required. At that time the controller activates a motor that drives a valve that has several positions corresponding to the backwashing, brining, rinsing and brine replenishing steps of the regeneration process.

One type of a water softener valve comprises a housing with a bore that has several chambers to which an inlet, an outlet and internal passages are connected. A piston with recesses and lands slides within the bore to selectively interconnect the different chambers and thereby direct water in different paths through the valve depending on the operating step. Separate sealing rings are placed in annular grooves in the bore between chambers. The seals engage the lands of the piston to block undesired water flow between the chambers.

In another type of water softener valve the motor that is adapted drives cam shaft which operates a plurality of flapper-type valves within the valve housing. A cam is associated with each valve and moves the flapper away from a surface inside the valve housing to open a passage. The valves are opened in different combinations to direct water through the different passages for the associated with the steps of the regeneration process. Here too seals are required to prevent water from flowing in unwanted paths between components of the control valve.

Regardless of the type of water softener valve, assembly requires that the various seals by properly placed on the respective components. By definition the seals must tightly engage the various valve components in order to provide a good seal there between. Such tight engagement is also required so that the seal does not dislodge during the assembly process before the abutting components are secured in place. That tight fit makes the assembly process time consuming and difficult to automate.

Therefore a need exists to create a seal that is easy to install during valve assembly and yet provides a water tight seal between the adjacent components of the valve.

### SUMMARY OF THE INVENTION

A sealing ring is provided for a water treatment apparatus that has a first component with a first surface and a second component with a second surface that faces the first surface and has an annular groove therein. The sealing ring has an annular body for placement in the annular groove to form a water tight seal between the first and second components of the water treatment apparatus. The sealing ring body has an inner perimeter and an outer perimeter with at least one fin projecting away from one of the inner perimeter and the outer perimeter. The fin is for engaging a wall of the annular groove and spacing the respective inner or outer perimeter away from the wall.

During assembly of the water treatment apparatus, the fin or fins rather than the entire inner perimeter or outer perimeter engage the groove wall. This engagement enables the sealing ring to be easily pressed into the groove as the relatively small contact areas between the sealing ring and the groove surfaces reduce the friction as the sealing ring is inserted thereby which facilitating assembly of the water treatment apparatus.

In a preferred embodiment, a plurality of fins, e.g. four fins, project from either the inner perimeter or outer perimeter of the annular body. Preferably the fins are equidistantly spaced around the respective perimeter. In addition the fins may have substantially constant thickness and have a edge that extends in a curve between two ends abutting the respective perimeter of the annular body.

### DESCRIPTION OF THE OF THE DRAWINGS

FIG. 1 illustrates components of a water softener that has a control valve in which the present sealing ring is used;

FIG. 2 is a cross sectional view through a portion of the control valve showing the present sealing ring;

FIG. 3 is a plane view of the sealing ring;

FIG. 4 is a cross sectional view taken through the along line 4-4 in FIG. 3; and

FIG. 5 is a plane view of another embodiment of the sealing ring;.

### DETAILED DESCRIPTION OF THE INVENTION

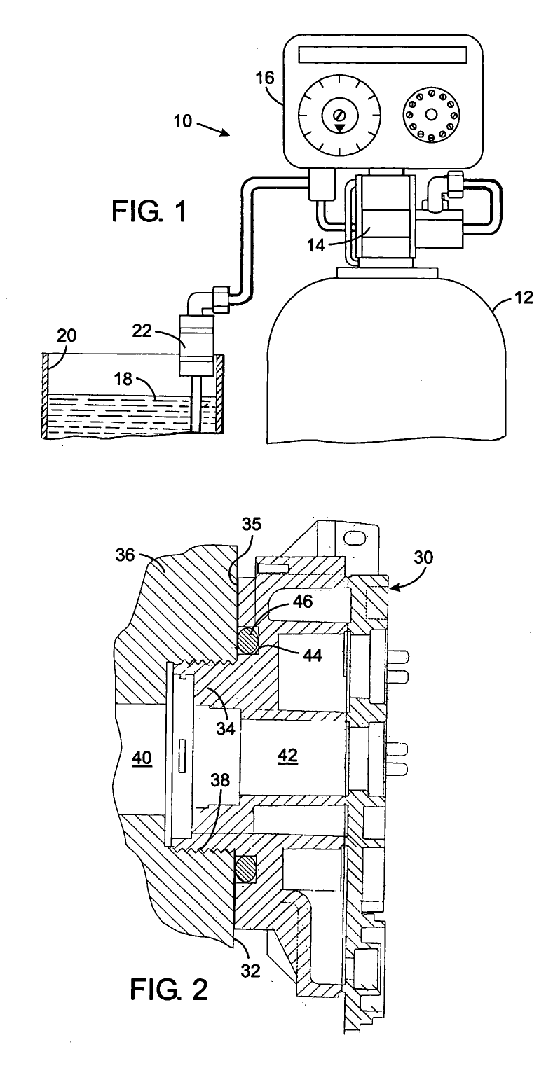

Referring initially to FIG. 1, a water softener 10 includes a treatment tank 12 which contains a conventional bed of ion exchange resin particles. A control valve 14 is fixed to the top of the treatment tank 12. In the service mode, hard water to be softened flows through the control valve and into the treatment tank 12 in which it continues to flow through the resin bed that absorbs minerals from the water. After traveling through the resin bed the water exits the treatment tank 12 flowing again the control valve 14 to an outlet connected to the pipes in a building.

The resin bed within the treatment tank 12 eventually becomes exhausted and no longer is capable of softening the water. At that time, an electrically powered controller 16 initiates a standard regeneration process. The controller 26 is fixed to the top of the control valve 14 and has a motor that operates the valve through the defined stages of the regeneration process.

A typical resin bed regeneration process commences with a backwash step in which hard water is directed from the control valve 14 backwards through the resin bed (in a flow direction opposite to that of the softening process) and finally exiting the water softener via a drain passage. The backwash step is followed by a brining step in which a salt solution 18 is drawn into the control valve from a brine tank 20. The salt solution comprises a common salt, such as a sodium chloride or potassium chloride. The concentrated salt solution replaces the di-positive and tri-positive ions in the resin bed with unipositive ions recharging the bed. When the contents of the brine tank 20 have been consumed, a check valve 22 closes to prevent air from being injected into the system and supply water without the salt solution continues to flow through the treatment tank 12. That water flow rinses the resin bed to remove any residual brine.

During the final stage of the regeneration process, the brine tank 20 is refilled with water and the softener resin bed within the treatment tank 12 is purged by continuing the send water through the resin bed and into the drain passage. Thereafter, the control valve 14 is returned to the position that places the water softener 10 into the previously described service mode in which the water for the building in treated.

FIG. 2 illustrates components inside the water softener with a unique seal that provides a water tight connection between the two components. Specifically a fitting 30, fabricated of molded plastic, has a cylindrical, tubular coupling 34 projecting outward from an external surface 35. The coupling 34 has threads on its outer circumferential surface that engage threads of an aperture 38 in the valve housing 36 of the control valve 14 so that a passage 40 in the valve housing communicates with a passage 42 in the fitting 30. The fitting 30 has an annular groove 44 in the external surface 35 and extending around the coupling 34.

A unique sealing ring 46 is received in the annular groove 44 of the fitting 30 being compressed between the fitting and the adjacent surface of the control valve housing 36. That engagement of the sealing ring 46 provides a water tight seal between the fitting 30 and the control valve housing 36.

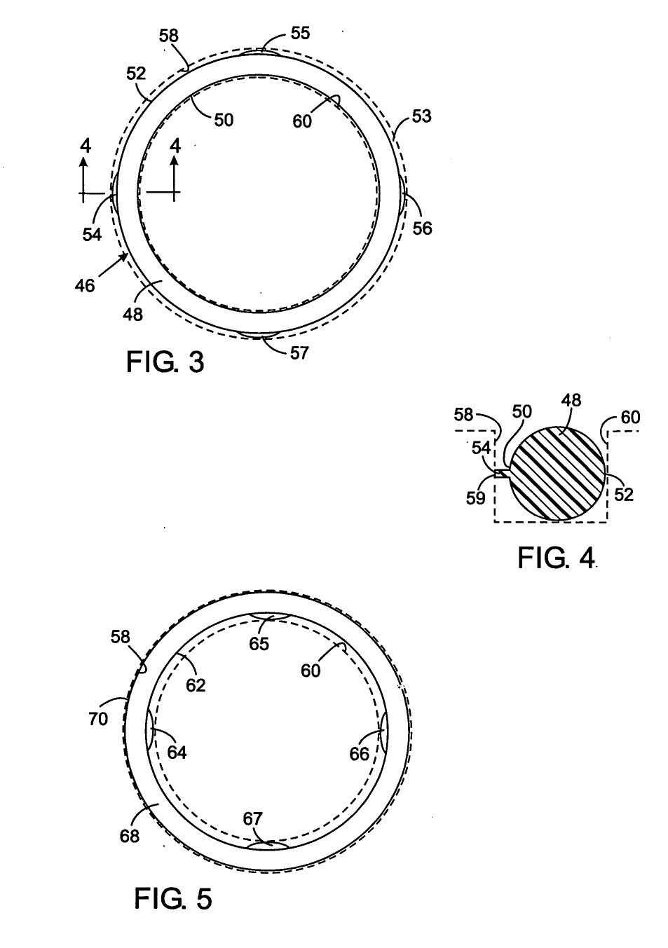

With reference to FIGS. 3 and 4, the sealing ring 46 has a body 48 circular cross section with a circumferential inner perimeter 50 and a circumferential outer perimeter 52. However, other geometrical cross sectional shapes may be employed. Four curved fins 54, 55, 56 and 57 project outward from the outer perimeter 52 of the sealing ring body 48 at 90° increments. A greater or lesser number of fins may be provided, especially depending upon the size of the outer perimeter 52. As seen in FIG. 4 regarding fin 54, the thickness of each fin is substantially constant and relatively small in comparison to the cross sectional diameter of the sealing ring. For example, for a sealing ring that has an outer diameter of 90.00 mm and a cross sectional diameter (or thickness) of 5.33 mm, each fin is 0.32 mm thick and projects 0.76 mm from the outer perimeter 52. Thus each fin has a thickness that is less than one-tenth the thickness of the body, and preferably greater than one-twentieth the thickness of the body. It also is preferred that each fin projects from the body a distance that is less than one-tenth the thickness of the body. Each fin 54-57 has a edge 59 that extends in a curve between two ends abutting the outer circumferential perimeter of the annular body, as best seen in FIG. 3.

The sealing ring 46 is placed into the groove 44 prior to assembling the fitting 30 on the control valve housing 36. In the past, the sealing ring was required to have either an inner or outer perimeter that entirely engaged the corresponding adjacent surface of the groove 44 in a tight manner to prevent the sealing ring from falling out of the groove during subsequent assembly steps. That snug engagement made it difficult to insert the sealing ring, as the ring either had to be stretched around the inner circumferential wall 60 of the groove (depicted by the smaller dashed circle) or compressed against the opposite outer circumferential wall 58 (depicted by the larger dashed circle). Such assembly often was a manual, time demanding process, especially when manufacturing tolerances make the fit of some sealing rings particularly tight.

However, the body 48 of the present sealing ring 46 has a inner diameter that is approximately the same as or slightly greater than the inner diameter of the groove 44 so that friction between the respective circumferential surfaces does not restrict insertion of the sealing ring into the groove. Similarly the outer diameter of the sealing ring body 48e is slightly less than the outer diameter of the groove 44, thereby forming a gap 53 there between. Upon inserting the sealing ring into the groove 48, outer edges of the fins 54-57 rub against the outer circumferential wall 58 of the groove. However, the relatively small regions of contact between the fins and that groove wall do not provide significant resistance to the insertion. Nevertheless, that contact provides sufficient resistance to prevent the sealing ring from dislodging from the groove during subsequent assembly steps or storage of the subassembly that occur before the fitting 30 is fully mounted on the control valve housing 36.

When the fitting 30 is fully secured to the valve housing 36 by threading the into the aperture 38, the sealing ring is compressed between those components of the control valve 14. In that compressed state, the entire inner perimeter 50 of the sealing ring 46 is squeezed against the inner circumferential wall of the groove 44 in the fitting and against the surface 32 of the valve housing, thereby providing a seal that prevents water within passages 40 and 42 from leaking between the fitting and the valve housing 36.

Alternatively as shown in FIG. 5, the fins 64-67 can be located on the inner perimeter 62 of the sealing ring body 68 and engage the inner circumferential wall 60 of the groove 44. In this alternative design, the smooth outer perimeter 70 of the body 68 sealingly engages the outer circumferential wall 58 of the groove 44. In some applications, fins could be provided on both the inner and outer perimeters of a sealing ring in which case a water tight seal is provided by engagement with the bottom surface of the groove and not the curving side walls.

The foregoing description was primarily directed to preferred embodiments of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A sealing ring for a water treatment apparatus that has a first component with a first surface and a second component with a second surface that faces the first surface and has an annular groove in the second surface, said sealing ring comprising:
an annular body for placement in the annular groove to provide a water tight seal between the first and second components of the water treatment apparatus and having an inner perimeter and an outer perimeter, the annular body including a fin that has a thickness which is less than one-tenth a thickness of the annular body, that projects away from one of the inner perimeter and the outer perimeter for engaging a wall of the annular groove, and that spaces the one of the inner perimeter and the outer perimeter away from the wall, wherein the other of the inner perimeter and the outer perimeter is without any fins.

2. The sealing ring as recited in claim 1 further comprising a plurality of fins projecting from the one of the inner perimeter and the outer perimeter of the annular body.

3. The sealing ring as recited in claim 2 wherein the plurality of fins are equidistantly spaced around the one of the inner perimeter and the outer perimeter.

4. The sealing ring as recited in claim 1 wherein the fin has a substantially constant thickness.

5. The sealing ring as recited in claim 2 wherein each fin has a thickness that is less than one-tenth a thickness of the body.

6. The sealing ring as recited in claim 5 wherein the fin has a thickness that is greater than one-twentieth a thickness of the body.

7. The sealing ring as recited in claim 1 wherein the fin projects from the body a distance that is less than one-tenth a thickness of the body.

8. The sealing ring as recited in claim 1 wherein the fin has an edge that extends in a curve between two ends abutting the one of the inner perimeter and the outer perimeter of the annular body.

9. A sealing ring for a water treatment apparatus that has a first component with a first surface and a second component with a second surface that faces the first surface and has an annular groove therein, said sealing ring comprising:
an annular body for placement in the annular groove to provide a water tight seal between the first and second components of the water treatment apparatus and having an inner perimeter and an outer perimeter, the annular body including a plurality of fins projecting less than one-tenth a thickness of the body away from one of the inner perimeter and the outer perimeter for engaging a wall of the annular groove and spacing the one of the inner perimeter and the outer perimeter away from the wall, wherein the other of the inner perimeter and the outer perimeter is without any fins.
projects from the body a distance that is less than one-tenth a thickness of the body.

10. The sealing ring as recited in claim 9 further comprising four fins projecting at ninety degree increments around the one of the inner perimeter and the outer perimeter of the annular body.

11. The sealing ring as recited in claim 9 wherein the plurality of fins are equidistantly spaced around the one of the inner perimeter and the outer perimeter.

12. The sealing ring as recited in claim 9 wherein each of the plurality of fins has a substantially constant thickness.

13. The sealing ring as recited in claim 9 wherein each fin has a thickness that is less than one-tenth a thickness of the body.

14. The sealing ring as recited in claim 13 wherein each fin has a thickness that is greater than one-twentieth a thickness of the body.

15. (canceled)

16. The sealing ring as recited in claim 9 wherein each fin has an edge that extends in a curve between two ends abutting the one of the inner perimeter and the outer perimeter of the annular body.

17. A sealing ring for a water treatment apparatus that has a first component with a first surface and a second component with a second surface that faces the first surface and has an annular groove therein, said sealing ring comprising:
an annular body for placement in the annular groove to provide a water tight seal between the first and second components of the water treatment apparatus and having an outer perimeter, the annular body including a plurality of fins that has a thickness less than one-tenth a thickness of the body, that projects away from the outer perimeter for engaging a wall of the annular groove, and that spaces the outer perimeter away from the wall, wherein the inner perimeter is without any fins.

18. The sealing ring as recited in claim 17 wherein four fins are located at ninety degree increments around the outer perimeter of the annular body.

19. The sealing ring as recited in claim 17 wherein the plurality of fins are equidistantly spaced around the outer perimeter.

20. The sealing ring as recited in claim 17 wherein each fin has a substantially constant thickness.

21. The sealing ring as recited in claim 1 wherein the annular body has a portion for engaging the first surface of the first component, wherein that portion is without any fins.

22. The sealing ring as recited in claim 9 wherein the annular body has a portion for engaging the first surface of the first component, wherein that portion is without any fins.

23. The sealing ring as recited in claim 17 wherein the annular body has a portion for engaging the first surface of the first component, wherein that portion is without any fins.
